(19) United States
(12) Patent Application Publication
(10) Pub. No.: US 2014/0304228 A1
(43) Pub. Date: Oct. 9, 2014

(54) Keyword-Based Dynamic Advertisements in Computer Applications

(71) Applicant: Murugappan Palaniappan, Issaquah, WA (US)

(72) Inventor: Murugappan Palaniappan, Issaquah, WA (US)

(73) Assignee: Adobe Systems Incorporated, San Jose, CA (US)

(21) Appl. No.: 11/870,847

(22) Filed: Oct. 11, 2007

(51) Int. Cl. G06F 17/30

(52) U.S. Cl. 707/634; 707/E17.009

(57) ABSTRACT

Methods and computer readable media for keyword-based dynamic advertisements in computer applications are described. One embodiment includes a method comprising the steps of receiving context information associated with a user interaction within an application window, receiving a response set comprising at least one article, the response set based at least in part on the context information, selecting an article from the response set, and causing the article to be displayed within the application window without reloading the application window.

### FIELD OF THE INVENTION

The present invention generally relates to content delivery, and more specifically relates to dynamic keyword-based advertisements in computer applications.

### BACKGROUND

Conventional methods for providing advertisements to a computer user typically display advertising to the user on a web page based on the static content of the web page at the time the page is scanned or crawled by a search engine or an advertisement provider or based on keywords supplied by a user in a search box. For example, a web page may be regularly crawled by an advertising provider to generate keywords, which are used to retrieve advertising for display on the web page when it is loaded in a browser. Such advertising may not change as a user interacts with the web page. In some advertising methods, different advertisements may be displayed only when a web page is reloaded, or a user navigates to a different web page. Further, some advertisements may be retrieved and/or displayed only when an application is connected to the Internet.

### SUMMARY

Embodiments of the present invention provide methods and systems for keyword-based dynamic advertisements in computer applications. For example, one embodiment of the method comprises the steps of receiving context information associated with a user interaction within an application window, receiving a response set comprising at least one article, the response set based at least in part on the context information, selecting an article from the response set, and causing the article to be displayed within the application window without reloading the application window. In another embodiment, a computer-readable media comprises code for carrying out such a method.

These illustrative embodiments are mentioned not to limit or define the invention, but to provide examples to aid understanding thereof. Illustrative embodiments are discussed in the Detailed Description, and further description of the invention is provided there. Advantages offered by various embodiments of this invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 is a block diagram illustrating a first system for keyword-based dynamic advertisements in software applications according to one embodiment of the present invention;

FIG. 2 is a block diagram illustrating a second system for keyword-based dynamic advertisements in software applications according to one embodiment of the present invention;

FIG. 3 is a screen shot illustrating an application according to one embodiment of the present invention;

FIG. 4 is a flow chart illustrating a first method for keyword-based dynamic advertisements in software applications according to one embodiment of the present invention; and

FIG. 5 is a flow chart illustrating a second method for keyword-based dynamic advertisements in software applications according to one embodiment of the present invention.

### DETAILED DESCRIPTION

Embodiments of the present invention provide systems and methods for keyword-based dynamic advertisements in computer applications. Methods according to the present invention may be embodied in a number of ways. Certain embodiments of the present invention may, for example, dynamically display advertisements based on keywords associated with the content in an application.

### Example of Keyword-Based Dynamic Advertisements in a Rich Internet Application

In one illustrative embodiment of the present invention, a computer system running computer software for Internet browsing displays a web browser application window. Within the browser application window, a rich Internet application displays various content. The content may comprise one or more objects, such as a picture or a text box. Users may interact with the content of an application in an application window, i.e. perform a user interaction, in a variety of ways. As one example of a user interaction, a user may select an image. The user interaction generates context information, such as a keyword, which is received by the rich Internet application.

Context information may be generated manually by a user, such as by associated one or more keywords with an image, or automatically, such as through scanning the textual content of a text area. The rich Internet application may also determine environment information associated with the user interaction, such as a user's locale, the time of year, seasonal information, or user profile information. As two examples, the user's Internet Protocol address (“IP address”) or Global Positioning System (GPS) coordinates may be used to estimate a user's geographic location. As another example, user profile information may include information related to user interactions with a plurality of applications.

In the illustrative example, the rich Internet application sends context information and/or environmental information to an advertisement server. In response, the advertisement server generates a request for advertisements based on the context information. Such a request may cause one or more advertisement providers to return one or more advertisements to the advertisement server in the form of a response set. This response set may be revised according to a preferred advertiser list, and returned to the rich Internet application.

Following receipt of one or more advertisements, the rich Internet application may store the response set in a local cache. The rich Internet application may also select an advertisement from the response set to display. The rich Internet application then dynamically displays the advertisement within the application window. For example, the advertisement may be displayed alongside or as part of the content displayed within the application window by the rich Internet application without reloading the content or refreshing the entire display. In certain embodiments, for example, the process of receiving context information, receiving advertisements, choosing the advertisements to be displayed, and displaying the advertisements may occur concurrently or substantially simultaneously with a user's interaction with a rich Internet application. Substantially simultaneously, as used herein, means that the advertisements are displayed as the user interacts with the application. The advertisements may appear to be displayed at the same time from the user's perspective or may be displayed somewhat after the interaction due to limitations in processing power on the computer or bandwidth on the network connection. In one embodiment, the advertisements are displayed within one second of the user's interaction.

This example is given to introduce the reader to the general subject matter discussed herein. The invention is not limited to this example. Further details regarding various embodiments of keyword-based dynamic advertisements are described below.

### Illustrative Environments for Dynamic Advertising

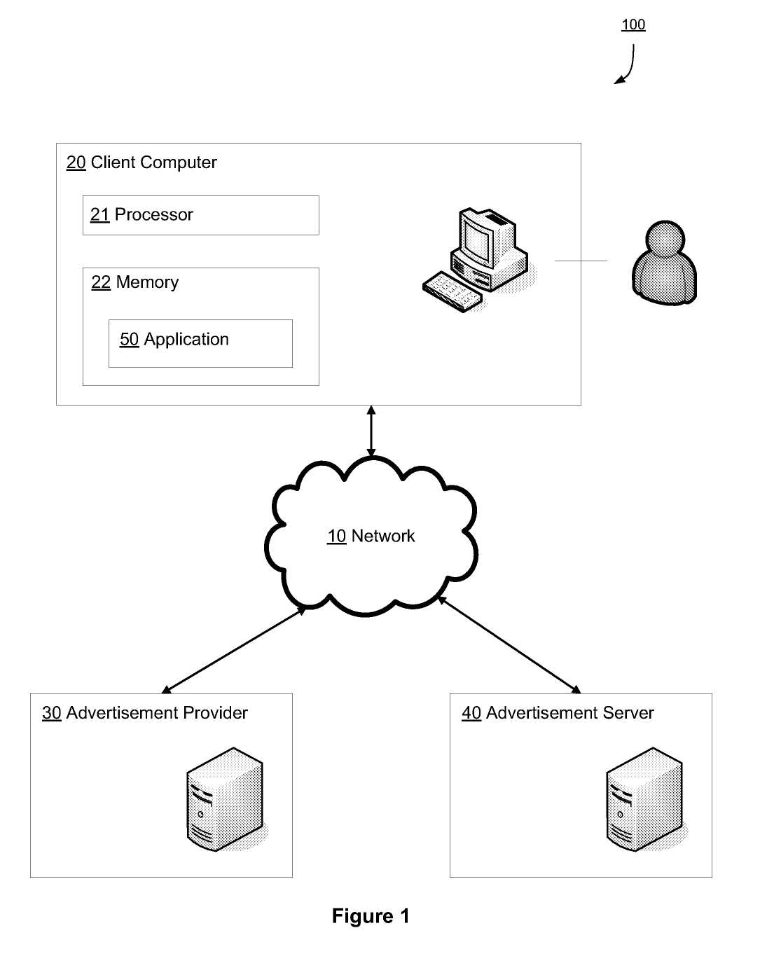

Referring now to the drawings in which like numerals indicate like elements throughout the several figures, FIG. 1 is a block diagram illustrating a first system for keyword-based dynamic advertisements in software applications according to one embodiment of the present invention. Other embodiments may be utilized. FIG. 1 illustrates an exemplary computing environment for executing an application, such as an Adobe® Integrated Runtime (AIR™) application, capable of keyword-based dynamic advertising.

The system 100 shown in FIG. 1 comprises a wired or wireless network 10 connecting a client computer 20, an advertisement provider 30, and an advertisement server 40. The client computer 20 and/or the advertisement server 40 may be in communication with one or more advertisement providers 30. The client computer 20 may communicate directly with one or more advertisement providers 30, or in one alternative, indirectly through an advertisement server 40. In certain other embodiments the client computer 20 may not be connected to a network 10. Although FIG. 1 illustrates the client computer 20 in communication with an advertisement server 40 and an advertisement provider 30, the client computer may be in communication with other devices, such as a content server or a content provider.

Client computer 20 comprises a processor 21 and a memory 22. Application 50 resides in memory 22, and may be executed by processor 21. As is known to one of skill in the art, such applications may be resident in any suitable computer-readable medium and execute on any suitable processor. For example, the client computer device may comprise a computer-readable medium such as a random access memory (RAM) 22, coupled to a processor 21 that executes computer-executable program instructions stored in memory. Such processors may comprise a microprocessor, an ASIC, a state machine, or other processor, and can be any of a number of computer processors, such as processors from Intel Corporation of Santa Clara, Calif. and Motorola Corporation of Schaumburg, Ill. Such processors comprise, or may be in communication with, media, for example computer-readable media, which stores instructions that, when executed by the processor, cause the processor to perform the steps described herein.

Embodiments of computer-readable media comprise, but are not limited to, an electronic, optical, magnetic, or other storage or transmission device capable of providing a processor with computer-readable instructions. Other examples of suitable media comprise, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other devices that transmit or carry instructions to a computer, including a router, private or public network, or other transmission device or channel, both wired and wireless may also comprise various forms of computer-readable media. The instructions may comprise code from any suitable computer-programming language, including, for example, C, C++, C#, Visual Basic, Java, Python, Perl, and JavaScript.

In the embodiment shown in FIG. 1, the network 10 shown comprises the Internet. In other embodiments, other networks, such as an intranet, or no network may be used. Moreover, methods according to the present invention may operate within a single device. The devices 20, 30, and 40 can be connected to a network 10 as shown. Alternative configurations are possible. Communication over the network 10 may be facilitated by one or more communications protocols such as the Transmission Control Protocol (TCP) or the Internet Protocol (IP).

Examples of client computer 20 are personal computers, digital assistants, personal digital assistants, cellular phones, mobile phones, smart phones, pagers, digital tablets, laptop computers, Internet appliances, and other processor-based devices. In general, a client computer 20 may be any type of processor-based platform that operates on any operating system, such as Microsoft® Windows® or Linux, capable of supporting one or more client application programs 50. One or more client applications 50 may be stored in memory and may comprise, for example, a video game, a word processing application, a spreadsheet application, an e-mail application, a media player application, an instant messenger application, a presentation application, an Internet browser application, a rich Internet application, a calendar/organizer application, and any other application or computer program capable of being executed by a client device.

The client computer 20 may be in communication with the advertisement server 40. In one example, an ad client executing on the client computer 20 may be in communication with a plurality of advertisement servers 40. In the embodiment shown, the client computer 20 provides context information, such as keywords or stock symbols, to the advertisement server 40. The client computer 20 may provide other information, such as environment information, to the advertisement server 40.

In the embodiment shown in FIG. 1, the advertisement server 40 receives information from client computer 20, and generates a request for at least one advertisement from one or more advertisement providers 30. In another embodiment, a content server (not shown) may receive information from a client computer 20 and generate a request for an article such as a stock quote or weather forecast from one or more content providers.

Advertisement server 40 may comprise several components, such as an accounting component and a developer services component (not shown). Each component may comprise various modules configured to perform various tasks. Examples of modules include an ad brokering module, a master keyword list module, a security module, or a click tracking module. A master keyword list module, for example, may check a master list to see whether a specific word is likely to trigger ads based on data collected through a web search.

The accounting component may act as a broker between an advertisement provider 30 and computer applications operating on a client computer 20. For example, the ad providers may only have knowledge of the accounting component, and direct advertisement revenue to the accounting component. The accounting component may then disburse some or all of the revenue to the client applications. In one embodiment the accounting component may disburse advertisement revenue according to various accounting methods. As an example, the accounting component may disburse advertisement revenue to each client application based on the client applications share of displayed advertisement impression or clicked links. A developer services component may comprise modules including a registration module, a payment history module, and a software development kit module.

In the embodiment shown, one or more advertisement providers 30 respond to a request for an advertisement by providing a response set comprising at least one advertisement. For example, an advertisement provider 30 may receive a request for an advertisement comprising one or more keywords. In response, an advertisement provider 30 may provide at least one advertisement to the advertisement sever 40. Advertisement provider 30 may comprise a third party advertisement provider. In certain embodiments, advertisement provider 30 may comprise a Google AdSense provider, a Microsoft adCenter provider, or a Yahoo! Publisher Network provider. In one example, each one of a plurality of advertisement providers responds to a request for an advertisement. In such an example, the response set may comprise advertisements from a plurality of advertisement providers.

In the embodiment shown, advertisement server 40 receives a response set comprising at least one advertisement in response to a request for advertisements. The advertisement server 40 then provides either the entire response set or a subset of the response set comprising at least one advertisement to the client computer 20. Client computer 20 may then cause at least one advertisement from the subset to be displayed.

Certain embodiments of the present invention relate to methods of dynamic advertising in rich Internet applications, for example dynamic advertising in a browser. It will be recognized that this is merely one context for a method of dynamic advertising. Certain embodiments may not involve a network and certain embodiments may not involve a rich Internet application. In short, the techniques for dynamic advertising and the other features described herein have uses in a variety of contexts, not to be limited by the specific illustrations provided herein. It should also be noted that embodiments of the present invention may comprise systems having different architecture than that which is shown in FIG. 1. The system shown in FIG. 1 is merely illustrative and is not intended to recite any system component or feature as essential or necessary to any embodiment of the invention.

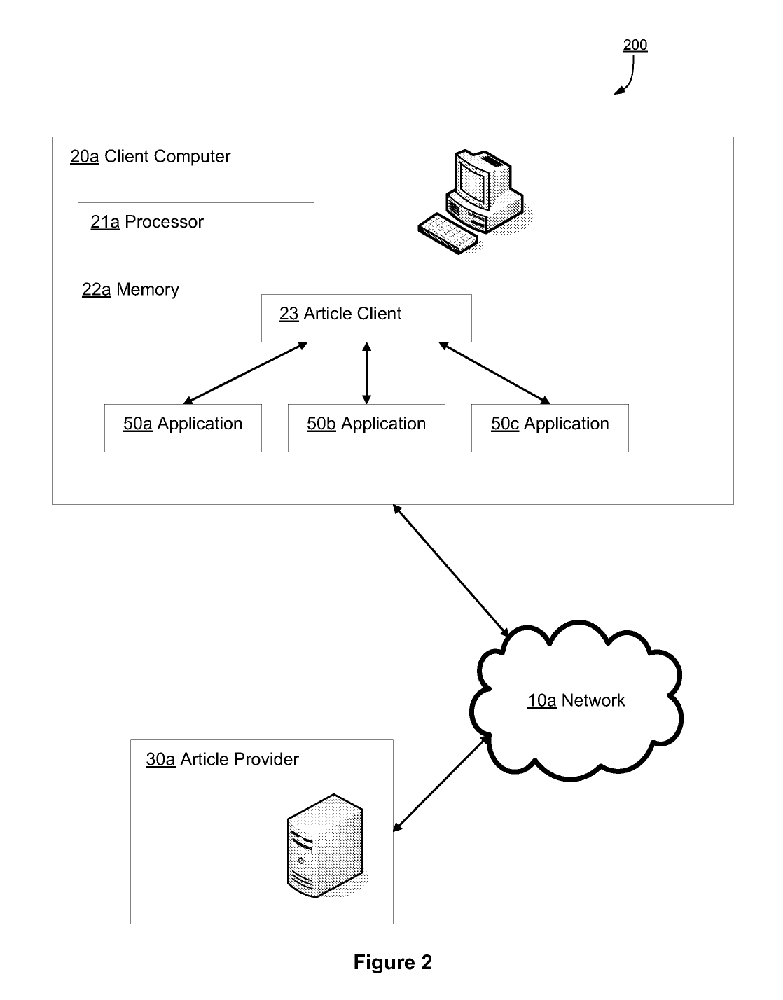

FIG. 2 is a block diagram illustrating a second system for keyword-based dynamic advertisements in software applications according to one embodiment of the present invention. The system 200 shown in FIG. 2 comprises a client computer 20a in communication with an article provider 30a over a network 10a.

Client computer 20a comprises a processor 21a and a memory 22a. Article client 23 and applications 50a, 50b, and 50c reside in memory 22a, and may be executed by processor 21a. Applications 50a, 50b, and 50c may comprise applications such as an Internet browser, a media player, a word processor, or a personal computer game.

Article client 23 may be in communication with applications 50a, 50b, or 50c. Article client 23 may be configured to receive context information and/or environment information generated by applications 50a, 50b, and 50c. In one example, article client 23 and applications 50a, 50b, or 50c may be executing simultaneously, and sharing information directly. In another example, the applications may execute at different times, and share information through a file stored in memory, such as a user profile.

Article client 23 may communicate with one or more article providers 30a over a network 10a. In another embodiment, article client 23 may communicate with an advertisement server 40, which may communicate with an article provider 30a. Article client 23a may comprise one or more modules, such as an ad display user interface, a keyword tokenizer, a keyword matching, a timer, a cache, a security module, a usage tracking module, or an environment module.

### Screen Shot of a Dynamic Advertisement

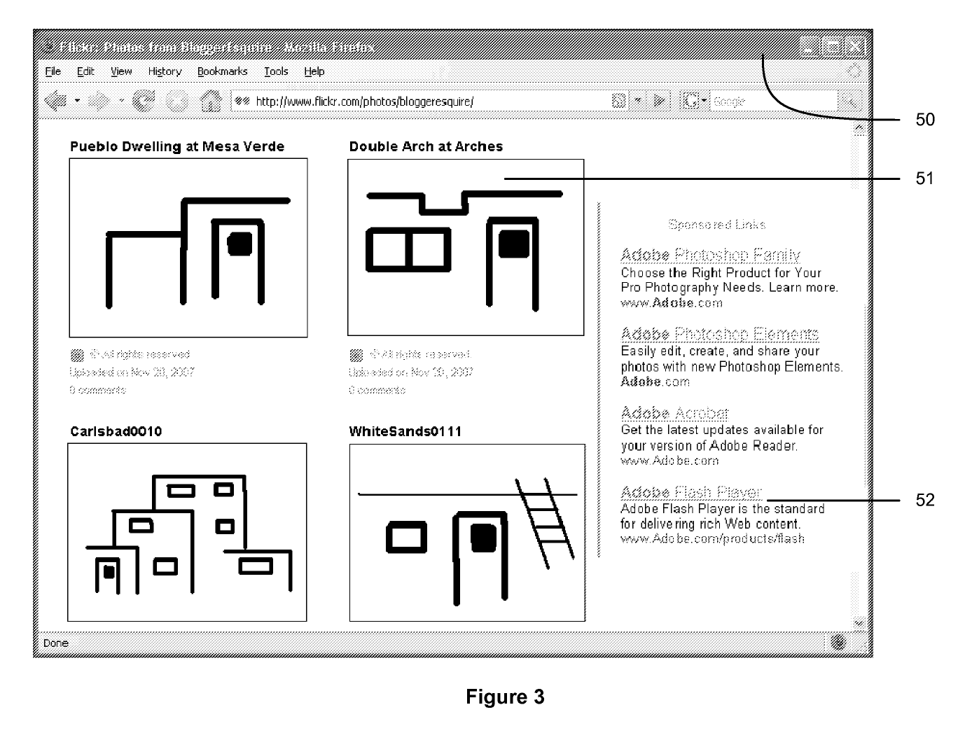

FIG. 3 is a screen shot illustrating an application according to one embodiment of the present invention. As an illustrative example, an application 50 executing in memory 22 could be displayed on the client computer 20, for example, on a display coupled to the client computer 20. Application 50 may execute within a web browser, for example, as an Adobe® Flash® application. In another example, Application 50 may execute as a stand-alone desktop application. Application 50 may comprise content 51 and one or more articles 52 shown within an application window. Application 50 may be configured to load and display content 51 formatted in html or xml. Articles 52, such as advertisements, stock quotes, or weather forecasts, may be formatted in html, xml, or in other non-text formats, such as an image format. In other embodiments, articles may comprise other types of content, including for example, entertainment information, weather, news, travel updates, and other information. These are merely examples of article types and should not be construed as limiting.

As illustrated in FIG. 3, the application window may be organized such that content is displayed alongside advertisements. In one example, content 51 may be shown in one portion of the application window, while one or more articles 52 are displayed in another portion of the application window. In another example, content 51 may be located in one column of a table shown in the application window, while articles 52 are displayed in a separate table column. Articles 52 may be blended with the content. As an example, in a computer video game that displays a sports stadium, a predefined template representing a billboard may be populated with one or more articles.

A user may interact with content 51, i.e. perform a user interaction. In the illustrated embodiment of FIG. 3, content 51 comprises images and text. In certain other embodiments, content 51 may comprise audio files, video files, buttons, selection boxes, radio button inputs, text entry boxes, content from objects such as files dragged and dropped into an application, games, or other forms of content.

In one example of a user interaction with content 51, an image may be selected, such as by clicking on an image, or dragging a selection box over an image. Other examples of user interactions may include selecting an option or a field, entering data into a form, printing a document, copying data onto a clipboard.

Each user interaction may generate context information, such as a keyword. Other forms of a context interaction may include a type of user interaction, a type of an object selected by a user, or a file name of an object selected by a user. Context information may be generated through other forms of user interaction, such as playing a browser-based Adobe® Flash® game or playing a multimedia file.

Context information associated with user interactions with the content 51 may be automatically generated, generated by a user, or specified by a content author. As one example, the author of an image may specify one or more keywords in the meta-information associated with an image. Alternatively, keywords may be generated through an automated analysis or an inspection of the content 51. In such an example, keywords may be generated by determining section headings and scanning for repeated or emphasized words in the text of content 51. As a further example, context information may be generated directly by the user, for example, from text entered into a text box.

In one illustration, content 51 may comprise an image or a picture. A user may interact with the picture by selecting it, typing a caption for the picture, and printing the picture out. Context information associated with these user interactions may comprise keywords describing the picture in the picture's meta data, the picture's file name, the caption text entered by the user, and the type of printer connected to the client computer.

An application developer may make certain controls or objects in the content 51 ad aware. For example, an AIR™ developer could mark a named area on their application for display of advertisements. A developer may add additional user interface controls such as a text area, selection box, or table. An ad aware control may be scanned automatically based on a certain event. For example, an ad-aware text box may be scanned automatically when a user completes a paragraph. An ad aware selection box or table may automatically scan a selected item when a user marks a box or selects an item in a table.

Context information may be triggered by certain events, or detection of those events. As an example, a “click” event may be detected, causing a clicked item to be scanned, and context information transmitted to the application 50. Other events may comprise a key press, a mouse event, or another form of user input.

In the embodiment shown in FIGS. 1 and 2, application 50 receives context information based on a user interaction with content 51. For example, application 50 may receive a keyword associated with an image selected by a user. Application 50 then sends a request for articles, such as advertisements, based on the keyword associated with the image. Application 50 may send the request for articles through an advertisement server 40, or directly to an advertisement provider 30.

In response to an article request, the application 50 receives a response set of at least one article. Articles in the response set may be in a text format, such as the hypertext markup language (html) format or an extensible markup language (xml) format. Alternatively, an article may be formatted in an image format, for example, as a .jpeg image or an animation format, for example, as a Flash animation. The response set of one or more articles may comprise a single html file including one or more articles. The response set may be based in part on a preferred provider list. For example, the advertisement server may return a response set comprising at least one specific advertisement listed in the preferred provider list. As another example, a content server may return a response set comprising stock quotes from a specific content provider based on their priority in a preferred provider list. The advertisement server may remove content based on an exclude list.

After receiving a response set of articles, the application 50 may select an article from the response set, and cause the article to be displayed 52. In one example, application 50 may receive a response set including several weather forecasts of varying detail. Application 50 may then select a specific forecast from the response set to display alongside the content. Application 50 may select the forecast based on information stored in a user profile, such as which forecast providers are preferred by a user.

As the user interacts with the content 51, the application 50 may dynamically receive, select, and display additional or different articles based on the user interaction. In one example, as a user selects a picture of a window in the application 50, the application 50 dynamically displays advertisements related to replacement windows or window washing fluid. Other examples of Articles such as advertisements may be displayed or changed as a user interacts with a single webpage, rather than as a user reloads a web page or navigates to a different webpage.

### Illustrative Embodiments of Methods of Dynamic Advertisement

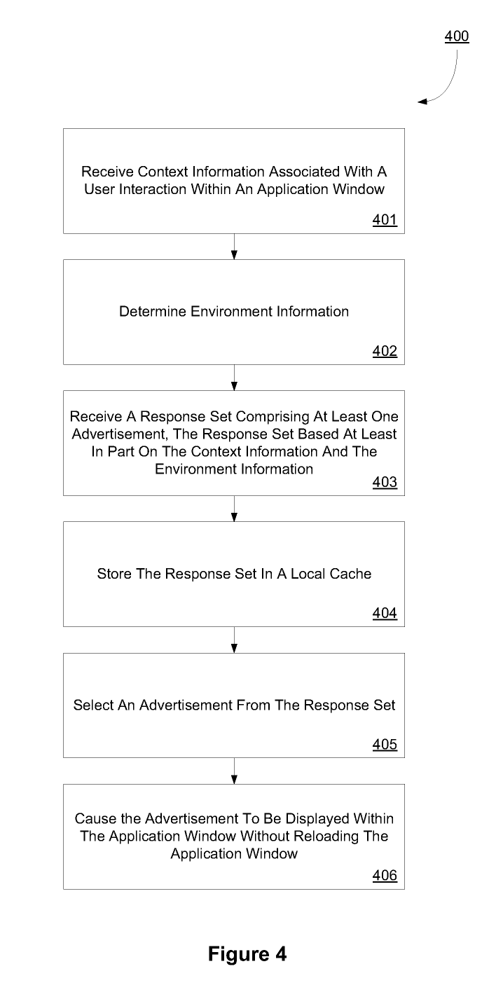

FIG. 4 is a flow chart illustrating a first method for keyword-based dynamic advertisements in software applications according to one embodiment of the present invention. For purposes of illustration only, the elements of this method are described with reference to the system depicted in FIG. 1. A variety of other implementations are also possible.

The method 400 begins in block 401, where the application 50 receives context information associated with a user interaction within an application window. The application 50 may be any type of computer application, including, for example, a rich Internet application or, a desktop application. Examples of rich Internet applications include Adobe® Flash® applications or Asynchronous JavaScript and XML (Ajax) applications. As an alternative to a browser-based application, certain embodiments of the invention may be designed to run independent of a browser. For example, the application may comprise an Adobe® AIR™ application designed for desktop deployment. The context information may comprise one or more keywords.

A user interaction may comprise an interaction with the content 51 within a window of an application 50. Some user interactions may be text-based. For example, a user interaction may comprise the entry of a word, sentence, or paragraph. Alternatively, a user interaction may comprise dragging and dropping a file into the application, such as a text file.

Other user interactions may be based on interacting with other forms of content 51. As examples, user interactions may include selecting a group or a particular item from a list, adding a new item into a list, selecting a row or column, or selecting some other object.

Receiving context information may be event driven. For example, when the application 50 detects an action taken by the user, the application 50 may execute specific code. In a certain embodiment, when a user enters text into a form field and navigates to a second form field, the application 50 detects one or more of these events. The application 50 may then execute code, for example, to determine what the user entered into a form field, or to which field the user navigated.

A user interaction may cause the application 50 to execute code during or after a user interaction. In one example, when the application 50 detects that a user is beginning to type into a text field, the application 50 immediately begins to scan the text as it is entered into the text box. In another example, the application 50 may wait to execute code after a specific action, such as the click of a button, moving the focus to a different control, or pressing the Enter key.

As one example, a user interaction may comprise the selection of an image. As another example, a user interaction may comprise moving a cursor over a specific area of an application. Other examples of user interactions may comprise selecting an option, entering data onto a form, printing a document, copying to the clipboard, or playing a media file.

Context information may be based at least in part on author information provided by a content author. For example, the author of a web page may add a meta tag to an image. When there is a user interaction with that image, the tag of the image may be received by the application.

In certain embodiments, the context information may be automatically generated. For example, the context information may be based on an automatic examination of content. For example, application 50 may scan the content of a web page to determine appropriate context information. Application 50 may scan the body text, hyperlinks and headings for context information. In some embodiments, context information may be keywords extracted directly from the content 51. In other embodiments, context information may comprise information calculated from the available content 51. For example, application 50 may scan the content of hyperlinks or look for specific attributes in meta data to offer clues to the content being viewed. Framework controls of specific content 51, such as text areas or combination boxes, may be configured to be “smart” such that the controls are automatically scanned for relevant context information.

In certain embodiments a media file may be scanned for lyrics, captioning, cues, or other meta information. A media file such as an mpeg-1 audio layer 3 (mp3) sound file may have meta information in an ID3 tag. A video file may include closed captioning information, with text of spoken audio during a video.

Some media files may contain cue points. As the media file is played, keywords or other information may be associated with specific cue points. As an example, during playback of a movie, when a cue point is reached, the application 50 may extract content information, such as keywords, from that point in the media file. This cue point information may be used to trigger content specific to that point in the media file.

Context information may also be automatically generated as a user alters or edits information. For example, an image file may be scanned as a user edits an image in the Adobe® Photoshop image-editing software application.

In block 402, the application 50 determines environment information. Environment information may include a user's location, a user's locale, or seasonal information. In one example, environment information may comprise a rough approximation of a user's location determined by analyzing a user's IP address. In another example, environment information may comprise seasonal information such as significant cultural, local, or national holidays, or weather trends. Such information may be stored, for example, in a file on the user's computer or on a server in communication with the user's computer. In another embodiment, the shared information may be available to a plurality of desktop and AIR™ applications.

Environment information may also comprise information associated with a user profile. A user profile may comprise information gathered across one or multiple applications. For example, an application 50 may access a user profile created by a first application, and modified by a second application. As such, the user profile may information associated with a plurality of applications. A user profile may include context information from one or more applications, and/or other information. Some examples of information included in a user profile include user preferences, browsing history, keywords associated with a user, advertisements displayed to the user, or advertisements clicked by the user.

In block 403, the application 50 receives a response set comprising at least one advertisement, the response set based at least in part on the context information and the environment information. As one example, a response set may be based in part on an image clicked by a user and in part on the user's locale. In such an example, when a user who clicks an image of the Seattle Mariners in Japan, the application 50 may receive a response set of content in the local Japanese dialect related to Major League Baseball.

In one example, a response set may comprise advertising promotions for stores near a user's location. As the user moves closer to individual stores, that specific store's promotion may be displayed. In another example, a response set for a video game may comprise advertisements based on the user's level or the teams playing in the video game.

The contents of the response set may be based on criteria unknown to the application user. For example, a user may be unaware of a preferred provider list that affects the contents of a response set returned by an application server 40. Such a preferred provider list may be generated and maintained by an application provider unbeknownst to a user of the application. In some embodiments, vendors may bid or compete on specific keywords. For example, a car dealership may secure a spot on a preferred provider list for keywords related to a specific model and location relevant to the car dealership.

In block 404, the application 50 stores the response set in a local cache. The application may use the local cache based on the status of the network. For instance, the application 50 may store the response set in the local cache when a connection with the advertisement server 40 is unavailable or when the connection is slower than is optimal for downloading advertisements. A local cache may comprise, for example, a file on the user's hard drive that contains the advertisements.

In certain embodiments, a response set stored in a local cache may be associated with additional information, such as an expiration date. The application may select the advertisements from the cache based at least in part on the additional information. In one such example, the application 50 will not display an advertisement stored in the local cache that, based on the expiration date, has expired.

In certain embodiments, a request for an advertisement may yield no results from the advertisement providers. In such an example, the context information and/or the environment information may be used to select an advertisement from the cache. The application 50 may also select advertisements from a cache when a connection to the network 10 is unavailable.

In block 405, the application selects an advertisement from the response set. The application may select an advertisement from the response set based at least in part on the environment information.

In certain embodiments application 50 may select an advertisement from a local cache prior to a user interaction based at least in part on the environment information. For example, after an application displays content 51, the application 50 may select advertisements from a local cache based on the user profile to display with the content 51.

In block 406, the application 50 causes the advertisement to be displayed within the application window without reloading the application window. Reloading an application window may comprise accessing a remote server to download the most current version of content displayed in an application window. Because certain embodiments of the present invention may display advertisements dynamically within the application window such methods are advantageous to other forms of web-based advertising which may rely on reloading the content of an application window to display or update advertising. In certain embodiments, the content within the application window does not need to change for the advertising to update dynamically within the application window.

The application 50 may display one or more advertisements dynamically with the user interaction. In certain embodiments one or more advertisements are displayed concurrently with, or within one second following a user interaction. The dynamic display of the advertisements may comprise updating the advertising display in an application based at least in part on a user interaction, in contrast to updating an advertising display based on a server refresh of content.

Application 50 may be configured to allow a user to scroll through the displayed advertisements. Application 50 may be further configured to allow the user to save selected advertisements locally.

In certain embodiments, the application 50 may select and display a plurality of advertisements from the response set. In certain embodiments, the application may order the display of advertisements based on the environment information. For example, an advertisement frequently shown to a user may be displayed below advertisements seen less frequently by a user.

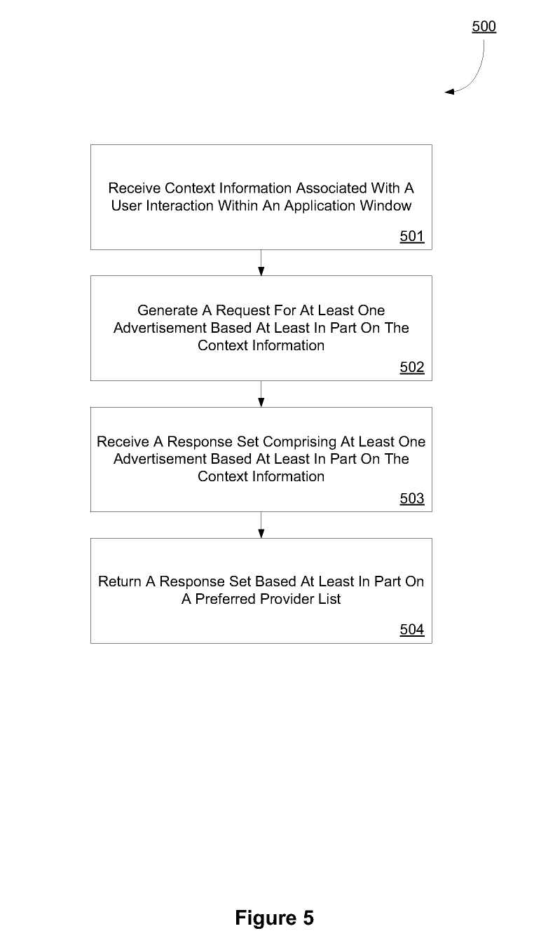

FIG. 5 is a flow chart illustrating a second method for keyword-based dynamic advertisements in software applications according to one embodiment of the present invention. For purposes of illustration only, the elements of this method are described with reference to the system depicted in FIG. 1. A variety of other implementations are also possible.

Method 500 begins with block 501, where the advertisement server 40 receives context information associated with a user interaction from the application 50. In certain embodiments, the advertisement server 40 may also receive environment information. In certain embodiments an advertisement client on the client computer 20 may receive the context information and forward it to a content or advertisement server 40.

In block 502, the advertisement server 40 generates a request for at least one advertisement based at least in part on the context information. In an example, the advertisement server sends a request to each advertisement provider 30 comprising one or more keywords received from the application 50. In an alternative embodiment, an advertisement client on the client computer 20 may generate a request and send it directly to one or more advertisement providers 30.

In block 503, the advertisement server 40 receives a response set comprising at least one advertisement, the response set based at least in part on the context information. The advertisement server 40 may receive a response set from one or more advertisement providers 30. The response set may comprise a plurality of html, xml, or text based advertisements which are managed by the advertisement server 40.

In block 504, the advertisement server 40 may return a response set to the application 50 based at least in part on a preferred provider list. A preferred provider list, for example, may comprise a list of specific, preferred advertisers or advertisements. In certain embodiments, the preferred provider list may reside on the advertisement server 40, and be updated without any interaction with the client computer 20. For example, the developer of the application 50 may maintain a preferred provider list routinely distributed to the advertisement server 40. In such a fashion advertisements provided to the user within the application may be based in part on the user's interaction with the application, and in part on current preferences of the application developer. In other embodiments, the response set returned to the application 50 on the client computer 20 is not based on a preferred provider list.

Embodiments of the present invention provide various advantages over convention advertising methods. For example, one advantage of a method for dynamic keyword-based advertisements in rich Internet and desktop applications is that articles such as advertisements, news, travel updates, and other information may be displayed to a user within an application window without reloading other content of an application window from a server. In contrast, conventional methods may serve advertisements when an application is reloaded, or a web page is refreshed from a server.

By using context information and/or environment information, dynamic articles displayed in the application window may be more suitably targeted to an individual user. For example, an advertisement based on context information may directly correspond with the interactions a user is performing within an application. As another example, news based on context information and environment information may be targeted to both the actions a user is performing on a web page and where the user is located.

Further, an article based on environmental information may correspond with other information gleaned from a user, such as the location or holiday season of a user, resulting in more relevant content being displayed to a user. As an example, an advertisement for a warm winter coat may be displayed in an application window for a user in one hemisphere, while an advertisement for cool tropical shorts may be displayed in an application window at the same time for a user in another hemisphere. In another example, the keyword “cake” may yield advertisements for graduation cakes in regions and locales during traditional graduation seasons (i.e. late May for the United States).

Another advantage of one embodiment for dynamic keyword-based advertisements in computer applications is that a single platform such as the advertisement server 40 may be used to retrieve advertisements from multiple advertisement providers. The advertisement server 40 may then use a preferred provider list to select a subset of advertisements in the response set of advertisements. In this fashion an application developer may manipulate which advertisements are ultimately displayed in the application window without modifying an application distributed across many client computers. According to one embodiment, an application developer may upload a new preferred partner relationship list to an advertisement server 40 without making any change to an application residing on a client computer 20. In another embodiment, a plurality of master keyword lists may be updated based on different criteria. Different keyword lists may be associated with different geographic regions or locales. For example, the keyword phrase “cinco de mayo” may not be used in Asia, whereas the keyword “hari raya” may not be used in the Americas.

Another advantage of dynamic keyword based advertisements is that advertisements may be displayed and refreshed in an application window even when the application does not have access to the Internet. For example, advertisements may be cached locally and selected from a cache depending on the status of a network connection.

Further, because a user profile may store a user profile on a local client computer, a user history may be built across various rich Internet and desktop applications. Such user history, possibly including, for example, a browser history or prior advertisement impressions, may be used to further enhance the selection of advertisements displayed in the application window. A user may prefer to read weather reports as graphical icons, or in Celsius rather than Fahrenheit. These preferences may be stored in the user profile, and cause specific weather forecasts to be requested, formatted accordingly, and displayed.

### General

The foregoing description of the embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the invention.

1-30. (canceled)

31. A computing system comprising:
a processor; and
a memory,
wherein the memory embodies program components comprising:
(i) a runtime application that configures the processor to provide a rumtime environment capable of executing at least one rich internet application;
(ii) an article client component executed within the runtime environment that configures the processor to retrieve an advertisement to be displayed; and
(ii) a first rich internet application executed within the runtime environment that configures the processor to:
display an object in a window,
receive input representing a user selection of the at least one object
while the object is displayed in the window by the first rich internet application,
in respoise to the input representing user selection of the at least one object, determine at least one keyword; and
provide the at least one keyword to the article client component,
wherein the article client component configures the processor to retrieve the advertisement based at least in part on the at least one keyword and in response to receipt of the at least one keyword from the first rich internet application.

32. The computing system set forth in claim 31, wherein the article client component configures the processor to display the retrieved advertisement.

33. The computing system set forth in claim 31, wherein the first rich internet application configures the processor to display the retrieved advertisement.

34. The computing system set forth in claim 33, wherein the article client component is included in the first rich internet application.

35. The computing system set forth in claim 31,
wherein the program components further comprise a browser application that configures the computing system to load a document referencing the first rich internet application and to launch the first internet application in the runtime environment, and
wherein the rich internet application configures the processor to display a first advertisement followed by a second advertisement without requiring the browser to reload the document.

36. The computing system set forth in claim 31,
wherein the program components further comprise a second rich internet application executed within the runtime environment that configures the processor to receive input representing selection of at least one second object and determine a keyword from the interaction with the second object, and
wherein the article client component configures the processor to retrieve an advertisement to display based on a keyword provided by both the first rich internet application and the second rich internet application.

37. The computing system set forth in claim 31, wherein the article client component configures the processor to retrieve the advertisement by providing a request comprising the keyword to a server.

38. The computing system set forth in claim 35, wherein the article client component further configures the processor to maintain a user profile and to include at least one additioial keyword in the request based on the profile.

39. The computing system set forth in claim 31, wherein the object is included in a form, the input representing a user selection of the at least one object comprises entry of text into the form, and the keyword is determined by analyzing the entered text.

40. The computing system set forth in claim 31, wherein selection of the at least one object comprises drawing a selection box around the at least one object.

41. The computing system set forth in claim 31, wherein selection of the at least one object comprises clicking on the object.

42. A computer-implemented method, comprising:
displaying, by a first rich internet application executed in a runtime environment provided by a processor, an object;
receiving, by the first rich internet application, input representing a selection of the displayed object;
in response to the selection of the displayed object, determining, by the first rich internet application, at least one keyword associated with the displayed object;
determining a second keyword based on data provided by a second rich internet application, the second rich internet application executed in the runtime environment and different from the first rich internet application;
retrieving, by the first rich internet application, an advertisememt, the advertisement retrieved by submitting a request to an advertisement provider, the request comprising the at least one keyword and the at least one second keyword; and
displaying, by the first rich internet application, the retrieved advertisement,
wherein the retrieved advertisement is displayed substantially simultaneously to selection of the displayed object.

43. The method set forth in claim 42, further comprising:
loading, by a browser application executed by the processor, a document referencing the first rich internet application,
wherein displaying the object, receiving input, retrieving the advertisememt, and displaying the retrieved advertisement are carried out after the rich internet application is loaded in response to loading of the document by the browser, and
wherein the retrieved advertisement is displayed without requiring the browser to reload the document.

44. The method set forth in claim 42, wherein the object is included in a form, the input representing a selection of the displayed object comprises entry of text into the form, and wherein the keyword is determined by analyzing the entered text.

45. The method set forth in claim 42, wherein selection of the displayed object comprises drawing a selection box around the object.

46. The method set forth in claim 42, wherein selection of the displayed object comprises clicking on the object.

47-48. (canceled)

49. A computer program product comprising a non-transitory computer-readable medium embodying program code, the program code comprising:
code for displaying, by a first rich internet application executed in a runtime environment provided by a processor, an object;
code for receiving, by the first rich internet application, input representing a selection of the displayed object;
code for determining, in response to the selection of the displayed object and by the first rich internet application, at least one keyword associated with the displayed object;
code for accessing data provided by a second rich internet application, the second rich internet application executed in the runtime environment and different from the first rich internet application;
code for retrieving, by the first rich internet application, an advertisement, the advertisement retrieved by submitting a request to an advertisement provider, the request identifying the at least one keyword and at least one second keyword determined from the data provided by the second rich internet application; and
code for displaying, by the first rich internet application, the retrieved advertisement,
wherein the retrieved advertisement is displayed substaitially simultaneously to selection of the displayed object.

50. The computer program product set forth in claim 49, wherein the object is included in a form, the input representing a selection of the displayed object further comprises entry of text into the form, and wherein the at least one keyword is determined by analyzing the entered text.

51. The computer program product set forth in claim 49, wherein selection of the displayed object comprises drawing a selection box around the object.

52. The computer program product set forth in claim 49, wherein selection of the displayed object comprises clicking on the object.

53-54. (canceled)

55. The method of claim 42, wherein the second rich internet application is executed in the runtime environment, but at a different time than execution of the first rich internet application.

56. The method of claim 42, wherein the second rich internet application and the first rich internet application are executed concurrently in the runtime environment.

57. The method of claim 42, wherein determining the second keyword based on data provided by the second rich internet application comprises accessing profile data provided by the second rich internet application.

58. The method of claim 57, further comprising updating, by the first rich internet application, the profile data after determining the at least one keyword associated with the displayed object.

59. The method of claim 58, further comprising:
executing the second rich internet application in the runtime environment and displaying, by the second rich internet application, a second object; and
determining, by the second rich internet application, a third keyword to use in retrieving an advertisement based on the updated profile data.
